(19) United States
(12) Patent Application Publication
(10) Pub. No.: US 2022/0132758 A1
(43) Pub. Date: May 5, 2022

(54) INTRODUCTION OF ACTIVE SUBSTANCES AND/OR DYE INTO PLANT TISSUE

(71) Applicant: Korte Luth GmbH, Wismar (DE)

(72) Inventors: Hans Korte, Wismar (DE); Peter Luth, Wismar (DE)

(21) Appl. No.: 17/312,874

(22) PCT Filed: Dec. 11, 2019
(86) PCT No.: PCT/EP2019/084617

§ 371 Date: Jan. 14, 2022

(30) Foreign Application Priority Data
Dec. 11, 2018 (DE) 10 2018 009 596.8

(51) Int. Cl. A01G 29/00; A01G 7/06; B27K 3/00; B27K 3/10

(52) U.S. Cl. CPC A01G 29/00; B27K 3/105; B27K 3/002; A01G 7/06

(57) ABSTRACT

Process for the treatment of plant tissue having a capillary system with active substances and/or dyestuffs, characterised in that a shaped piece containing openings and/or having grooves or knobs on its surface, the openings or surface structure of which are loaded with active substance and/or dyestuff, is applied to the plant tissue with the aid of a setting tool or setting device in such a way that no air penetrates into the capillary system.

### CROSS-REFERENCE TO RELATED APPLICATIONS

This application is a U.S. national stage of International Appl. No. PCT/EP2019/084617 filed Dec. 11, 2019, which claimed priority to German Appl. No. 10 2018 009 596.8 filed Dec. 11, 2018, which applications are all incorporated herein by reference in their entireties.

### TECHNICAL FIELD

When active substances are applied in the environment, they are often applied inaccurately, so that parts of the quantities of active substance used, e.g. when spraying, contaminate other plants or parts of plants, non-target organisms or soil and water that are not the target of the treatment. These can be damaged or contaminated with substances that either negatively affect the natural biological balance or enter the food chain and can ultimately be ingested by humans. In addition, due to the imprecise application of active substances, considerably higher quantities of active substances are applied than would actually be necessary for the intended purpose, which entails both ecological and economic disadvantages.

One task of the invention is therefore to remedy this deficiency of a conventional application of active substances. The active substances are to be applied precisely in a maximum required application quantity without contamination of other organisms or objects with the active substance to be applied.

In one embodiment, the invention solves the problem by applying active substances directly to target organisms. In another embodiment, dyes are applied directly into a target organism. In one embodiment, the active ingredients are of synthetic origin. In a further embodiment, the active ingredients are bio-based. The active ingredients also include organisms that exert an effect in the target organism. In one embodiment, the organisms are microorganisms. In one embodiment, the organisms are “organs” of microorganisms. In one embodiment, the “organs” of microorganisms are fungal spores. In one embodiment, the “organs” are fungal conidia. In one embodiment, the “organs” are chlamydospores. In one embodiment, the fungi are applied as sclerotia or sclerotial tissue. In one embodiment, the fungi are segments of fungal hyphae. In one embodiment, the microorganisms are bacterial cells. In one embodiment, the microorganisms are viruses. In one embodiment, the organisms are entomopathogenic nematodes. In one embodiment, the target organisms are plants with lignified stems. In one embodiment, the target organisms are plants with non-woody stems. In one embodiment, the plants with non-woody stems are papaya. In one embodiment, the targets are branches. In one embodiment, the targets are rhizomes. In one embodiment, the targets are roots. In one embodiment, the plants are plants with pseudostems. In one embodiment, plants with pseudostems are banana plants. In one embodiment, the plants are plants with woody inflorescences. In one embodiment, the plants are plants with non-woody inflorescences. In one embodiment, the plants are plants with thickened plant parts. In one embodiment, plants with thickened plant parts are cacti. In one embodiment, plants with thickened plant parts are agaves.

### BACKGROUND

Various solutions are known from the patent literature as to how a targeted application of chemically-synthesised active substances to a target site can be achieved. For example, methods are proposed in which the active substances are introduced into holes specially drilled in tree trunks (U.S. Pat. Nos. 3,971,159, 6,216,388 B1, 3,367,065). U.S. Pat. No. 3,137,388 proposes to coat conventional nails with a herbicide for use in controlling woody plants. The use of a nail setter is not proposed. The methods described may be suitable for chemically synthesised active substances, but are relatively complex and, if they were also to be used for biological active substances, in particular microbiological active substances, would require a fresh suspension of living microorganisms, which causes considerable difficulties under commercial conditions due to the low storage stability of such suspensions. Another method of introducing chemically synthesised active substances into trees is described in U.S. Pat. No. 5,914,295 and DE 4432127 A1. Here, the active ingredient is incorporated into a moulding consisting primarily of polymer components during the manufacturing process. An extrusion process is used in which high pressures of at least 50 bar and temperatures of at least 150° C. are applied. However, biological active ingredients, especially microbiological active ingredients, would not survive such a process due to the heat and pressure generated during the moulding of the thermoplastic polymer components.

Another method of introducing active ingredients into plants is the injection method as proposed for the control of nematicides in banana roots (Araya, M., 2004: Injection of Vydate® and Nemacur® into the banana (Musa AAA) follower sucker pseudostem for nematode control. CORBANA 2004, Vol. 30 (57): 59-75). The injection is made into the tissue of the pseudostem of banana, which is relatively easy to carry out due to the nature of the plant tissue. This is different when the injection is made into the stem of (woody) trees. For this purpose, a method has been developed to apply a biological agent. The product Dutch Trig, which is used as a preventive against Dutch elm disease (Scheffer R. J., Voeten J. and Guries R. P., 2008: Biological control of Dutch elm disease. Plant Disease, Vol. 92:192-200.), is injected into the stems of elms using an injection procedure. In the procedure, conidia of the fungus Verticillium albo-atrum are introduced as a conidial suspension into the sapwood of the elm, which involves considerable effort on the part of the person carrying out the procedure. In addition, a freshly produced conidial suspension is used, which entails considerable disadvantages, especially in terms of logistics. If it were possible to add the conidia of Verticillium albo-atrum to a formulation, this would have to be portioned and converted into an aqueous suspension before the injector could be filled.

DE 10 2016 007 093 A1 describes a method for treating wood using a hollow cylindrical body with cavities. The cavities, in which active substances can be accommodated, are connected to an internal punch. The cylindrical hollow body is driven into the trunk like a nail. To release the active substances, the internal plunger is pressed into the inside of the cylinder in a second step by means of a suitable lowering mould, whereby the cavities open at the front and/or side of the hollow body and active substance is released into the environment. The release of the active ingredient is therefore carried out by a separate step and the loading of the cavities, e.g. with conidial suspension, encounters the same difficulties as the injection process. The same would apply to formulations of other biological agents and other applications for the injection and “cylindrical hollow body” processes. Another disadvantage of the method is the costly production of the cylindrical hollow body and the high-strength properties that the push pin must have in order to be able to push the inner chambers forward into the wood.

A major disadvantage of the known methods is that air can penetrate into the plant tissue when the active ingredient carriers are introduced into the active site. This is obvious when a hole is drilled first, as for example in DE 10 2016 007 093 A1, but also applies to nails that are placed without pre-drilling but push the plant tissue apart during penetration, which can generally lead to an aliform gap in the direction of the fibres in cylindrical nails. The gap areas where the nail is not flush with the plant tissue are potential entry points for air. However, air is very harmful to the sap-conducting capillary system of plants, especially tall plants such as trees, palms or bamboo, because it interrupts sap transport. In order to prevent embolisms caused by air ingress, e.g. in the case of injuries due to wind breakage, animal damage, etc., trees have developed a protective system in evolution based on the closure of pits. The pits function like valves that interrupt the transport of liquid from one cell to the neighbouring cell and thus the transport of sap when air enters a cell. All systems that require or allow air to enter the plant tissue during the application of the active ingredient hinder the spread of the introduced active ingredient with the sap transport due to the air entry and the associated pit closure and are therefore to be regarded as disadvantageous.

### SUMMARY OF THE INVENTION

The starting point of the invention is the surprising finding that the introduction of living microorganisms into moulded bodies provided with openings ensures a long shelf life in the sense of preserving their biological activity. In one embodiment, the openings are pores. In one embodiment, this shelf life is also observed for “organs” of microorganisms. In one embodiment, the durability can also be produced by structuring surfaces. The moulded bodies to be inserted are spatially designed in such a way that they are suitable for applying active substances and/or dyes to their site of action without allowing air to enter the tissue of the target organism.

According to the invention, a shaped piece loaded with active ingredient and/or dye is applied directly into the target organism in a single operation without prior perforation of the target organism. The active substance and/or dye can spread in the target organism. The special shape of the moulded piece, which is similar in cross-section to a potential crack in the target organism, ensures that the moulded piece is flush with the plant tissue everywhere, thus preventing air from entering and the associated pit closure. The application through moulded pieces into the target organisms excludes any possible contamination of non-target organisms. Due to the targeted application, potentially toxic agents can also be used, which would otherwise not be applicable due to their high toxicity towards non-target organisms.

In another embodiment of the invention, the moulded parts for application with microbiological active substances are also provided with a nutrient substrate for the microorganisms at the same time as they are “filled” with the active substance. After application into living plant tissue, the microorganisms can develop on this nutrient substrate, thereby enhancing the effect.

In another embodiment of the invention, the shaped pieces are first filled with nutrient substrate. Subsequently, the mouldings are inoculated with microorganisms.

In one embodiment, trees are inoculated with endophytic microorganisms. In one embodiment, tree-like plants are inoculated with endophytic microorganisms. In one embodiment, trees are inoculated with entomopathogenic nematodes. In one embodiment, tree-like plants are inoculated with entomopathogenic nematodes.

In one embodiment of the invention, the wood of living trees is partially stained by application of dye-bearing mouldings in order to protect them from illegal logging or to render the use of their wood worthless.

The invention is described in detail below.

The invention relates to a process for treating plant tissue having a capillary system with active substances and/or dyes, characterised in that a shaped piece containing openings and/or having grooves or nubs on its surface, the openings or surface structure of which is loaded with active substance and/or dye, is applied to the plant tissue with the aid of a setting tool or setting device in such a way that no air penetrates into the capillary system.

### LIST OF REFERENCE SIGNS

X Spatial axis, in which the width of the moulding is indicated
Y Spatial axis, in which the thickness of the moulding is indicated
Z Spatial axis in which the length of the moulded part is indicated
α Angle at which the flanks of the head (3) are aligned to each other
β Angle in which the flanks of the tip (2) are aligned with each other.
1. shaped piece
2. front piece of the moulding (1)
3. head of the moulding (1)
4. flank of the head (3)
5. straight central part of the head (3) with a 180°.
6. polygonal cross section of the fitting (1)
7. rounded central part of the head (3)
8. spindle-shaped cross-section of the fitting (1)
9. convex curvature of the head (3) in the Y-axis
10. aliform cross-section of the moulded part (1)
11. convex curvature of the head (3) in the X-axis
12. airtight envelope of the head (3)
13. pores in the Y-axis in the moulding (1)
14. pores in the X-axis in the moulding (1)
15. pores in the Z-axis in the moulding (1)
16. pores in the Z-axis and pores at an angle of 10° to 90° to the Z-axis in the moulded part (1)
17. grooves in the surface in the Z-direction in the moulding (1)
18. grooves in the surface in the X-direction in the moulding (1)
19. grooves in the surface in Z- and X-direction in the moulding (1)
20. frame of the fitting (1)
21. central opening in the moulding (1)
22. central opening with grid structure in the moulding (1)
23. plunger of the setting tool or setting device
24. contour adaptation of the plunger in X-direction to the moulding (1)
25. contour adaptation of the ram in Y-direction to the moulding (1)
26. individual shaped pieces grouped in a magazine
27. sharpened front piece
28. sharpened front piece

### BRIEF DESCRIPTION OF THE DRAWINGS

The invention will now be explained more fully with reference to the drawings, in which:

FIG. 1 shows a variation of shaping in the variants a to e of the shaped pieces (1), in frontal, side and top view (upper row) as well as in spatial representation (lower row). The X, Y and Z axes are shown in a1 and the angles α for the head section (3) and β for the front section (2) are shown in b1.

FIG. 2 shows shaped pieces (1) which have openings in the form of pores which are
a) in the direction of the Y-axis (13)
b) in the direction of the X-axis (14) or
c) in the direction of the Z-axis (15) or
d) in the direction of the Z-axis as well as in the direction of the Y-axis (16).

FIG. 3 shows shaped pieces (1) with surface structuring in the form of grooves which
a) in the direction of the Z-axis (17) or
b) in the direction of the X-axis (18) or
c) in the direction of the Z-axis and in the direction of the X-axis (19).

FIG. 4 shows a moulded part (1) consisting of a frame (20) and a central opening (21).

FIG. 5 shows a shaped piece (1) consisting of a frame (20) and a central opening (21) which is filled with a grid (22).

FIG. 6 shows the ram (23) of a setting tool or a setting device with a shape adaptation to the shape of the head of the shaped piece (1) both in the X-axis (24) and in the Y-axis (25).

FIG. 7 shows a magazine (26) of shaped pieces (1) consisting of at least 2 shaped pieces (1).

### DETAILED DESCRIPTION OF THE INVENTION

In one embodiment, the shaped pieces are made of a bio-based material with natural pores. In one embodiment, the natural material is lignified plant tissue. In one embodiment, the natural material is hardwood. In one embodiment, the natural material is softwood. In one embodiment, the natural material is bamboo. In one embodiment, the natural material is from palm trees.

The advantage of shaped pieces made of lignified plant tissue is that when the shaped pieces are used on plants whose tissue is mechanically processed after harvesting, the shaped pieces do not interfere with the processing. In one embodiment, shaped pieces of wood loaded with active substance are applied to tree trunks of living trees. In the course of the tree's life, which continues over a period of years, the shaped piece is rolled over. When the tree is cut after felling, the wooden shaped piece does not cause any mechanical damage to the saw blades. The wooden shaped piece behaves like an ingrown branch in the piece of wood to be processed. If the tree is biologically decomposed, the wooden shaped piece behaves like an overgrown branch. The same applies if the tree is used to generate energy. In one embodiment, a shaped piece of beech is impregnated with a neonicotinoid. The shaped piece is shot into a spruce trunk infested by the bark beetle with a gas cramp nailer.

In one embodiment, the shaped pieces are made of a synthetic material with artificially created pores. In one embodiment, the synthetic material is plastic. In one embodiment, the synthetic material is thermoplastic resin. In one embodiment, the synthetic material is thermoset plastic. In one embodiment, the synthetic material is reinforced plastic. In one embodiment, the synthetic material is fibre reinforced plastic.

The advantage of shaped pieces made of synthetic materials is that the shaped pieces can be manufactured automized. In one embodiment, the shaped pieces are injection moulded. In one embodiment, injection moulding is used to produce several hundred thousand similar mouldings using one mould. The advantage of manufacturing by injection moulding is the low cost per piece. In one embodiment, the moulded parts are manufactured using additive manufacturing (3D printing process). In one embodiment, the mouldings are manufactured using selective laser sintering (SLS). In one embodiment, the moulded parts are manufactured using stereolithography (STL). In one embodiment, the shaped pieces are manufactured using fused layer manufacturing (FLM).

The advantage of additive manufacturing is that the shape of the mouldings as well as the shape and distribution of the pores can be easily varied. Another advantage is that additive manufacturing can be used to quickly produce small batches for testing new geometries.

In one embodiment, the shaped pieces have pores with a maximum cross-section of 2 mm. In one embodiment, the pores are filled with excipients containing active substances. In one embodiment, the pores are filled with excipients containing dye. In one embodiment, the excipients comprise gel-forming substances. In one embodiment, at least one gel-forming excipient comprises a bio-based material. In one embodiment, at least one gel-forming excipient comprises carbohydrates. In one embodiment, at least one gel-forming excipient comprises agar-agar. In one embodiment, at least one gel-forming excipient comprises protein. In one embodiment, at least one gel-forming excipient comprises gelatine. In one embodiment, at least one gel-forming excipient comprises a synthetic material. In one embodiment, at least one gel-forming excipient comprises polyacrylic acid. The advantage of gel-forming excipients is to displace air from the pores. In one embodiment, the advantage of gel-forming excipients is to increase the survival rate of microorganisms. In one embodiment, the advantage of gel-forming adjuvants is to increase the survival rate of microorganisms in the adjuvant-filled surface recesses of shaped pieces.

In one embodiment, shaped pieces made of materials having natural pores are additionally provided with artificial pores. In one embodiment, the artificial pores are created mechanically.

In one embodiment, the pores are created by means of electromagnetic waves. In one embodiment, the pores are cut using laser light.

The artificially created pores are at an angle of 10° to 90° to the natural pores. In one embodiment, the natural pores are oriented in the Z direction and the artificial pores are oriented at an angle between 10° and 90° parallel to the X direction. In one embodiment, the natural pores are oriented in the Z direction and the artificial pores are oriented at an angle between 10° and 90° parallel to the Y direction.

In one embodiment, a shaped piece has a central opening (20). In one embodiment, the opening is not greater than 50% of the rectified dimension of the moulding in its dimensions in the X-direction. In one embodiment, the aperture is not greater than 50% of the equidirectional extent of the moulding in its extensions in the Y-direction. In one embodiment, the extent of the opening in the Z-direction is no more than 90% of the extent of the moulding.

Instead of pores or in addition to pores, the surfaces of the shaped pieces may be provided with recesses. In one embodiment, the depressions consist of grooves (FIG. 3). In one embodiment, the depressions run in the X-direction (18). In one embodiment, the depressions run in the Z-direction (17). In one embodiment, the depressions run in both the X-direction and the Z-direction (19). The recesses are not wider than 50% of the width of the shaped piece. In one embodiment, the grooves are less than 15% of the width of the shaped piece.

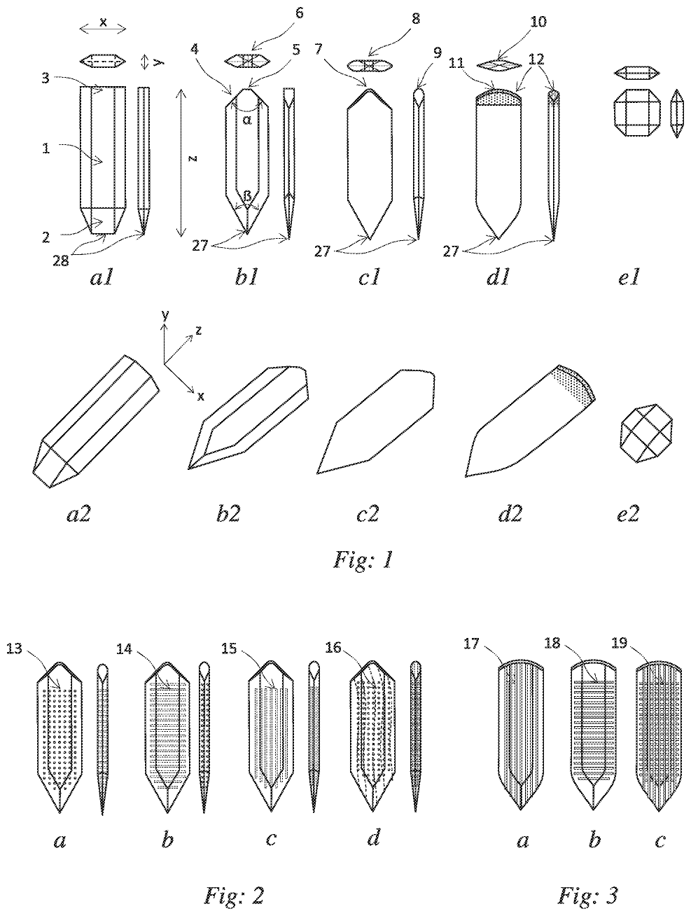

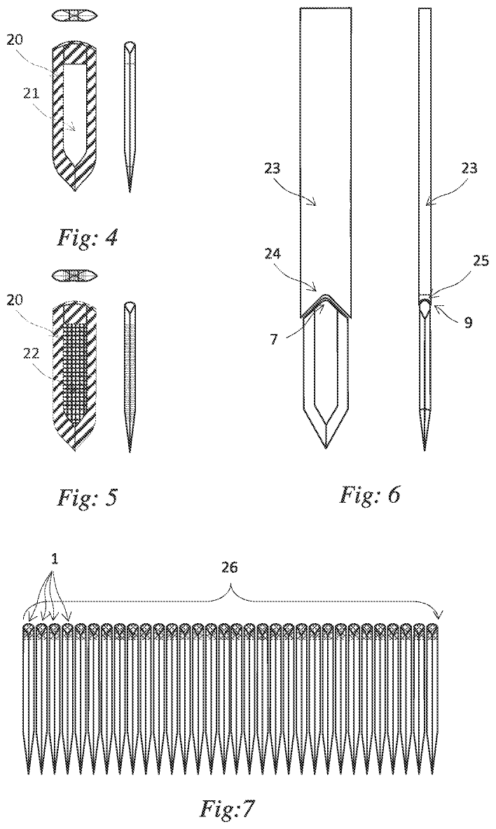

The shaped pieces are shown schematically in FIG. 1 to FIG. 5. In cross-section, they have a shape that largely corresponds to an aliform (eye-shaped) gap. Aliform gaps can be created by driving a cylindrical part into the wood of tree trunks. Shaped pieces with a cross-section that largely corresponds to an aliform gap create a form-fitting contact with the gap of the surrounding plant tissue. This prevents air from entering and thus an undesirable pit closure.

FIG. 1 shows typical shaped pieces, which have a polygonal (6), a spindle-shaped (8) or an aliform (10) cross-section, a front piece (2) and a head (3) opposite the front piece. The shaped pieces (1) are applied to the plant tissue with the front piece (2) first. In one embodiment, the orientation of the shaped piece (1) is substantially perpendicular to the longitudinal axis of the plant organ into which the shaped piece is applied. In one embodiment, the X-axis of the shaped piece is aligned parallel to the fibre course of the plant organ into which the shaped piece is applied. In one embodiment, the head (3) is formed with a straight edge in both the X and Y directions (FIG. 1 a). In another embodiment, the head is formed with a convex curvature (7, 11). In one embodiment, the head is formed with a double convex curvature in the X and Y directions (7, 11 and 9). In one embodiment, the head area is covered with an airtight envelope (12) to prevent air from entering the capillary system of the plant tissue via pores in the shaped piece.

The flanks (4) and curvatures of the head (7, 9, 11) serve to stabilise it when the shaped piece is set. With a straight design (a 180°) of the head (3) (FIG. 1a), there is a risk that edge areas will splinter off when the fibres of a shaped piece run at an angle. This happens easily when a setting tool is applied at an angle. In one embodiment, when working with setting tools, the impulse is so high that edge areas can splinter. The single (7, 11) or double convex curvature (7, 11 and 9) to which the ram (23) of the setting tool is adapted (FIG. 6) stabilises the edge areas during setting. The curvature of the plunger (23) encloses the head (3, 7, 9) of the shaped piece like a cap (24, 25). The curvatures (7, 24, 9, 25) simultaneously centre the shaped pieces during setting. This is particularly helpful if, in one embodiment, the fittings have different thicknesses. Such thickness variations can occur due to swelling effects during steam sterilisation. In one embodiment, swelling is caused by loading with sewing media. In one embodiment, swelling is caused by incubation with microorganisms in broth. In one embodiment, swelling is triggered by incubation with gel-forming auxiliary substances. If mouldings with thickness variations and straight heads (FIG. 1a) are lined up in a magazine and applied with a setting tool, there is a risk that the plunger (23) of the setting tool, instead of only acting on the head of one moulding, will simultaneously act on the edge of the following moulding, which can lead to its deformation and to clogging of the tool. Due to a convex curvature in the Y-direction of the moulded pieces (9) and the concave curvature in the ram (25), the shaped piece in line with the ram is centred in the ram during setting, while the following moulded piece in a magazine (26) is pushed back by the ram.

In one embodiment, FIG. 2a shows a flat, elongated, one-sided pointed shaped piece, which has holes in the Y-direction. In one embodiment, FIG. 2b shows rows of holes pointing in the X-direction. In one embodiment, FIG. 2c shows rows of holes pointing in the Z-direction.

In one embodiment, FIG. 3a shows a flat, elongated shaped piece, sharpened on one side, which has depressions on the surface running in the Z-direction. FIG. 3b shows an embodiment of a shaped piece with surface depressions in the X-direction. FIG. 3c shows an embodiment of a shaped piece with surface recesses in the Z and X directions.

Shaped pieces are applied to the plants or plant material by means of drive technology. In one embodiment, the application is done manually by hammering. In one embodiment, the shaped piece is held by a setting tool, which has a shape (24, 25) on the contact surface that matches the head of the shaped piece, when hammered in by a hammer. Setting tools have the advantage of a simple construction. They are inexpensive to manufacture. They do not constitute dangerous goods as baggage for air travel.

In one embodiment, the application is done mechanically with setting tools. Setting devices generally have the advantage of taking over the manual, power-consuming work of driving the shaped piece into a plant tissue by artificial drive. In one embodiment, compressed air devices are used as setting devices. In one embodiment, gas pressure devices are used. In one embodiment, vibrating devices are used. In one embodiment, the shaped pieces are applied to the target organism by means of vibration.

Gas pressure devices have the advantage of being able to be used independently of a compressed air station. This is of great advantage in plantations. The disadvantage is that the gas cartridges required for gas pressure devices may not be transported in the aircraft.

Shaped pieces are either fed individually to the setting apparatus or in magazine form (26) (FIG. 7), with at least 2 shaped pieces per magazine. A practical number is between 50 and several hundred shaped pieces per magazine, without defining an upper limit.

The use of a setting device for the application of the active ingredient via a shaped piece has the advantage over the above-mentioned injection method that it is much less time-consuming. The drilling of holes during the application of an active substance into a tree trunk, which is harmful because of air ingress, is no longer necessary.

In one embodiment, it was shown that microorganisms, after being introduced into a shaped piece, surprisingly exhibit a storage stability more than twice as long as in other formulations. In one embodiment, Gram-negative bacteria were introduced into a shaped piece and remained active for more than twice as long as the same bacteria in a suspension. In one embodiment, Pseudomonas spp. were introduced into a shaped piece that remained active for more than twice as long as the same bacteria in a suspension. In one embodiment, Serratia spp. were introduced into a shaped piece that remained active for more than twice as long as the same bacteria in a suspension.

In one embodiment, loading of the shaped pieces can take place without pressure. In one embodiment, the shaped pieces are immersed in active substance solution. In one embodiment, the shaped pieces are immersed in dye solution. In one embodiment, the shaped pieces are immersed in active substance suspension. In one embodiment, the shaped pieces are immersed in active ingredient emulsion. In one embodiment, the shaped pieces are immersed in active substance dispersion. It is advantageous if the pores develop a capillary effect and the active ingredients and/or dyes are absorbed by capillary forces. In order to increase the absorption of the active ingredient and/or dye, the shaped pieces can be made of wood artificially compressed by at least 20%, which swells during dipping and absorbs at least 10% more active ingredient and/or dye with the resulting negative pressure in the interior than is the case with non-compressed shaped pieces. An increase in the absorption of active agent and/or dye is also achieved by impregnation at pressures deviating from the normal pressure. In one embodiment, the shaped pieces are impregnated at negative pressure. In one embodiment, the shaped pieces are impregnated at overpressure. In one version, the shaped pieces are impregnated at alternating pressure. In practice, pressures of 0.05 bar to 15 bar are used, although lower or higher pressures should not be excluded.

In one embodiment, fungicidal agents are used. In one version, insecticidal agents are used. In one embodiment, bactericidal agents are used. In one embodiment, moluscicidal active substances are used. In one embodiment, acaricidal active substances are used. In one embodiment, rodenticidal active substances are used. In one embodiment, herbicidal active substances are used. In one design, active substances with a scrambling effect are used. In one embodiment, active substances with a growth-promoting effect are used.

In one embodiment, herbal active ingredients are used. In one embodiment, azadirachtin is used. In one embodiment, nicotine is used. In one embodiment, quassin is used. In one embodiment rotenone is used. In one embodiment, pyrethrin is used. In one embodiment, unpurified herbal active ingredients are used. In one embodiment, neem oil, an extract of the seeds of the neem tree (Azadirachta indica), is used.

In one embodiment, microorganisms are used that serve as inoculum for the production of fruiting bodies of mushrooms. In one embodiment, microorganisms are used that serve as inoculum for the production of interesting metabolites in plants.

Microorganisms can be introduced into the shaped pieces in a variety of ways. In one embodiment, shaped pieces made of wood are soaked with a culture substrate, sterilised, inoculated with a fungus, incubated for a particular time and then dried. In one embodiment, shaped pieces made of bamboo are soaked with a malt extract peptone broth, sterilised, inoculated with a bacterium and then dried. The fungus or bacterium penetrates the pores of the material during the culture process and forms “organs” there during the drying process at the latest.

In one embodiment, the “organs” are stromata. In one embodiment, the “organs” are sclerotia. In one embodiment, the “organs” are chlamydospores. In one embodiment, the “organs” are spores. In one embodiment, the “organs” are endospores. In one embodiment, the “organs” are resistant cells. In one embodiment, the “organs” are conidia. In one embodiment, the “organs” can survive viable in the material for an extended period of time.

Another possibility of introducing micro-organisms into the material of the material, which can also be used for dyes, is vacuum infiltration. In this process, the shaped pieces are placed in a microorganism suspension. In one embodiment, the shaped pieces are placed in a dye solution. The microorganism suspension may contain fungal “organs” such as spores, conidia, blastospores, chlamydospores, microsclerotia or hyphal segments either in pure form or in mixture. A corresponding suspension of bacteria or yeasts may contain cells or endospores. A viral suspension contains viruses, bacteriophages or components of viruses such as polyhedra or virones. The microorganisms or their organs are either purified or still mixed with a substrate, such as residues of culture medium, residues of plant material or haemolymph (in the case of insect viruses). A vacuum of up to approx. 0.05 bar is applied to the vessel containing the liquids with the moulded pieces, which is designed as a vacuum vessel. The air still present in the pores is then evacuated and the pores are filled with the microorganism suspension or colour solutions.

Another possibility for loading shaped pieces is to mix active substances with auxiliary substances and to introduce them into the moulded parts. In one embodiment, active ingredients are mixed with gel-forming excipients. In one embodiment, active ingredients are mixed with agar-agar. In one embodiment, active ingredients are mixed with gelatine. In one embodiment, active ingredients are mixed with polyacrylic acid. In one embodiment, the active ingredients mixed with gelling excipients are introduced into the openings of the mouldings before gelling. In one embodiment, the active ingredients mixed with gel-forming excipients are introduced into the openings of the shaped pieces after gelling. In one embodiment, in the case of shaped pieces with a large central opening (21) (FIG. 5), powder containing active substance is introduced into the central opening where it is compressed into a tablet. In one embodiment, a tablet containing active ingredient is introduced into the opening (21) of the shaped piece.

In one embodiment, the shaped pieces are loaded with active ingredient as individual pieces. In one embodiment, the shaped pieces are loaded with dye as individual pieces.

In another embodiment, several shaped pieces are loaded with active substance in a magazine. In another design, several shaped pieces are loaded with dye in a magazine.

The following fields of application are particularly emphasised.

### 1. The Control of Plant Diseases or Plant Pests

1.1 Control of the Wilt Pathogen Verticillium dahliae on Olive Trees (Olea europea)

The wilt pathogen Verticillium dahliae causes high yield losses in olive production worldwide. V. dahliae multiplies in the vascular system of the trees and leads to reduced yields and, in severe cases, ultimately to the death of the trees. There are hardly any commercial methods to control Verticillium wilt. However, endophytes such as Pseudomonas fluorescens, which develop symbiotically in olive trees, can inhibit wilt (Prieto P., Navarro-Raya C., Valverde-Corredor A., Amyotte S. G., Dobison K. F. and Mercado-Blanco J., 2009: Colonization process of olive tissues by Verticillium dahlia and its in planta interaction with the biocontrol root endophyte Pseudomonas fluorescens PICF7. Microb Biotech-nol., Vol. 2 (4): 499-511). In one embodiment, Pseudomonas spp. is introduced into wooden shaped pieces and dried. The dried shaped pieces are used to inoculate olive trees by applying the shaped pieces. In one embodiment, the shaped pieces of the invention are treated with the bacterium P. fluorescens strain PICF7 and applied to the base of the trunk in the trees. In one embodiment, the treatment has a curative effect. In one embodiment, the treatment has a protective effect.

1.2 Control of Armillaria Spp.

The fungus Armillaria spp. attacks numerous woody plants. These include avocado, citrus, oak, coffee, pine, kiwi, almond, peach, tea and grapevine, which can have a high economic value. It grows under the bark at the base of the stem. The fungus Trichderma spp. can be used for control. SAVAZZINI et al. (Savazzini F., Oliveira-Longa C. M. and Pertot I., 2009: Impact of the biocontrol agent Trichoderma atroviride SC1 on micro-bial soil communities of a vineyard. IOBC Bulletin, Vol. 43: 363-367) found that the Trichoderma strain T. atroviride SC1 is able to control the pathogen. Other possible Trichoderma strains, which just like SC1 are already used in commercial biological pesticides, are the strains T. harzianum T22 and T. harzianum T39.

In one embodiment, it is proposed to use shaped pieces treated with an effective Trichoderma strain to control Armillaria spp. In one embodiment, shaped pieces loaded with T. harzianum are applied at a distance of a few centimetres into the base of the trunk of trees threatened by infestation. In one embodiment, the loaded shaped pieces are applied to the exit points of the fruiting bodies of the harmful fungus of infested trees.

1.3 Control of the Wilt Pathogen Ralstonia solanacearum on Banana Plants

According to a paper by FUJIWARA et al. (Fujiwara A., Fujisawa M, Hamasaki R., Kawasaki T., Fujie M., and Yamada T., 2011: Biocontrol of Ralstonia solanacearum by Treatment with Lytic Bacteriophages. Appl. Environ Microbiol. vol. 77(12): 4155-4162), R. solanacearum can be successfully controlled by the use of bacteriophages. The φRSL1 strain in particular showed a good effect. Bacteriophages, namely the strains φRSSKD1, φRSSKD2 have also been successfully isolated from R. solanacearum on banana plants (Addy H. S., Azizi N. F. and Mihardjo P. A., 2016: Detection of Bacterial Wilt Pathogen and Isolation of its Bacteriophage from Banana in Lumajang Area, Indonesia. International Journal of Agronomy, Vol. 2016, Article ID 5164846, 7 pages). ÁLVAREZ et al. (Alvarez B. and Biosca E. G., 2017: Bacteriophage-Based Bacterial Wilt Biocontrol for an Environmentally Sustainable Agriculture. Front Plant Sci., Vol. 8: 1218) also report the successful use of bacteriophages for the control of R. solanacearum on bananas.

In one embodiment, shaped pieces treated with a bacteriophage effective against the wilt pathogen R. solanacearum are applied to banana plants. In one embodiment, shaped pieces treated with a bacteriophage active against the wilt pathogen R. solanacearum are applied near the base. In one embodiment, shaped pieces treated with a bacteriophage active against the wilt pathogen R. solanacearum are applied to the rhizome of the banana plant.

Another way of controlling R. solanacearum on banana plants is to use apathogenic strains of Ralstonia spp. But strains of the genus Mitsuaria can also be used (Marian M., 2018: Novel isolates of Ralstonia and Mitsuaria species as biocontrol agents for controlling tomato bacterial wilt. XV Meeting of the IOBC Woking Group “Biological and integrated control of plant pathogens”, Biocontrol products: from lab testing to product development. 23-26 Apr. 2018, Lleida).

In one embodiment, shaped pieces treated with apathogenic Ralstonia spp. are applied to banana plants according to the invention. In one embodiment, shaped pieces of the invention enriched with certain strains of other apathogenic genera are applied to banana plants. In one embodiment, the shaped pieces are applied into the rhizome.

1.4 Control of the Wilt Pathogen Xylelle fastidiosa on Olive, Citrus, Other Fruit Trees and Grapevines

The bacterium Xylelle fastidiosa causes high yield losses, particularly in the Mediterranean region, especially in olive plantations, and in the USA, especially on grapevines and citrus. In Europe, for example, 700,000 ha of olive plantations are said to be infected (oral communication by Maria Saponari at the Fourth International Symposium on Biological Control of Bacterial Plant Diseases, 9-11 Jul. 2019 in Viterbo, Italy). The bacterium also causes damage to almond trees, coffee bushes and peach trees. The disease, which sometimes leads to the death of the host plants, can be counteracted by the use of bacterial antagonists. It is known that the apathogenic strain of Xylella fastidiosa EB92-1 can significantly inhibit disease development on grapevines (Hopkins, D. L. 2005: Biological control of Pierce's disease in vineyard with strains of Xylella fastidiosa benign to grapevine. Plant Dis. 89: 1348-1352). Other authors found that the use of Paraburkholderia phytofirmans strain PsJN can also slow down the infestation of grapevines with X. fastodiosa (Baccari C., Antonova E, Lindow S. 2019; Biological Control of Pierce's Disease of Grape by an Endophytic Bacterium. Phytopathology, Vol. 119 (2): 248-256).

In one embodiment, shaped pieces are treated with the apathogenic strain of Xylella fastidiosa EB92-1 and then applied to the stem of grapevine.

In one embodiment, shaped pieces are treated with the apathogenic strain of Xylella fastidiosa EB92-1 and then applied to the trunk of citrus trees. In one embodiment, shaped pieces are treated with the apathogenic strain of Xylella fastidiosa EB92-1 and then applied to the trunk of olive trees. In one design, shaped pieces are treated with the apathogenic strain of Paraburkholderia phytofirmans strain PsJN and then applied to the trunk of grapevines.

1.5 Control of Wild Black Cherry (Prunus serotina) with the Fungus Chondrostereum purpureum

A forestry problem is that the wild black cherry and other woody plants, which occur in forests as “unwood”, can only be controlled with great difficulty. Mechanical removal of the shoots by means of saws or pliers usually leads to more shoots sprouting again than were removed, so that this costly measure is not sustainable and has to be repeated regularly. Products are known in which the fungus Chondrostereum purpureum is present as an active ingredient for the control of such woody plants, primarily the wild black cherry. Such products are, for example, the preparations Biochon, MycoTech Paste and Chontrol Peat Paste (Lygis V., Bakys R., Burokiené D. and Vasiliauskaité I., 2012: Chondrostereum purpureum-based Control of Stump Sprouting of Seven Hardwood Species in Lithuania. Baltic Forestry, Vol 18 (1): 41-55). The products, mostly in the form of mycelial suspensions or pastes, are applied to the cut surfaces after mechanical removal of the shoots, where the fungus develops, penetrates the plant and ultimately causes it to die. Apart from a very poor storage stability of the products, which are usually formulated as mycelial suspension or mycelial paste, the same disadvantages can be observed with this method as in the previously described application.

The liquids or pastes used may be washed off by the natural precipitation or dry out if the natural precipitation is too low, so that the fungus is unable to penetrate the wood.

In one embodiment, shaped pieces according to the invention are loaded with isolates of the fungus Chondrostereum purpureum and applied to the trunks of the wild black cherry.

1.6 Control of Ganoderma boninense on Oil Palms (Elaeis guineensis)

The fungus Ganoderma boninense can cause a rot, also called “basal stem rot”, at the base of the stems of oil palms. This ultimately leads to the loss of the infested palms and thus to high yield losses. The use of fungal (Yurnaliza N., Aryantha I. N. P., Esyanti R. R., Susanto A., 2014: Antagonistic Activity Assessment of Fungal Endophytes from Oil Palm Tissues Against Ganoderma boninense Pat. Plant Pathology Journal, Vol. 13 (4): 257-267) or bacteriel (Sapak Z., Meon S., and Ahmad Z. A. M., 2008: Effect of Endophytic Bacteria on Groth and Suppression of Ganoderma Infection in Oil Palm. International Journal of Agriculture & Biology 10 (2): 127-132) Endophytes can reduce palm infestation and the spread of rot in palms. Species of the genus Trichoderma in particular are named as fungal endophytes. For example, Trichoderma harzianum strain FA1132 showed a very good effect against G. boninense (Naher L., Tan S. G., Yusuf U. K., Ho C.-L. and Abdullah F., 2012: Biocontrol Agent Trichoderma harzianum Strain FA 1132 as An Enhancer of Oil Palm Growth. Pertinica J. Trop. Agric. Sci., Vol. 35 (1): 173-182). According to a paper by Naidu et al. (Naidu Y., Idris A. S., Madihah A. Z. and Kamarudin N., 2016: In vitro Antagonistic Interactions Between Endophytic Basidiomycetes of Oil Palm. (Elaeis guineensis) and Ganoderma boninense. Journal of Photopathology, Vol. 164 (10): 779-790), G. boninense can also be controlled by endophytic bacteria. In particular, species of the genera Burkholderia, Pseudomonas and Seratia are mentioned as bacterial endophytes.

In one embodiment, shaped pieces according to the invention are inoculated with Trichoderma harzianum FA1132 and subsequently applied to the stems of oil palms. In one embodiment, shaped pieces according to the invention are inoculated with Trichoderma harzianum FA1132 and then applied to the trunks of oil palms infested with Ganoderma boninense where fruiting bodies of the harmful fungus are visible. In one embodiment, shaped pieces according to the invention are inoculated with Burkholderia and then applied into the trunks of the oil palms. In one embodiment, shaped pieces according to the invention are inoculated with Burkholderia and then applied to the trunks of oil palms infested with Ganoderma boninense where fruiting bodies of the harmful fungus are visible. In one embodiment, shaped pieces according to the invention are inoculated with Pseudomonas and then applied into the trunks of the oil palms. In one embodiment, shaped pieces according to the invention are inoculated with Pseudomonas and then applied to the trunks of oil palms infested with Ganoderma boninense where fruiting bodies of the harmful fungus are visible. In one embodiment, shaped pieces according to the invention are inoculated with Seratia and then applied into the trunks of the oil palms. In one embodiment, shaped pieces according to the invention are inoculated with Seratia and then applied to the trunks of oil palms infested with Ganoderma boninense where fruiting bodies of the harmful fungus are visible.

1.7 Control of the Pine Wood Nematode Bursaphelenchus xylophilus on Pine Trees (Pinus Spp.)

The pine wood nematode (Bursaphelenchus xylophilus), which causes pine wilt, threatens large pine forest areas in the USA, Canada, Mexico, Japan, China, Taiwan, Korea, Portugal and Spain. It is treated as a quarantine pest in Europe. The fungus Esteya vermicola (strain CNU 120806) has been shown to control the pine wood nematode with good success (Wang Z., Zhang Y., Wang C., Wang Y and Sung C., 2017: Esteya vermicola Controls the Pinewood Nematode Bursaphelenchus xylophilus, in Pine Seedlings. J Nemotol. vol. 49 (1): 86-91).

In one embodiment, shaped pieces according to the invention are treated with Esteya vermicola (strain CNU 120806) and subsequently applied to pine logs for curative treatment. In one embodiment, shaped pieces according to the invention are treated with Esteya vermicola (strain CNU 120806) and subsequently applied to pine trunks for protective treatment. In one embodiment, shaped pieces according to the invention are treated with Purpureocillium lilacinum (strain PL251) and subsequently applied to pine trunks for curative treatment. In one embodiment, shaped pieces according to the invention are treated with Purpureociffium lilacinum (strain PL251) and then applied to pine trunks for protective treatment. In one embodiment, shaped pieces according to the invention are treated with Pochonia chlamydosporia and subsequently applied to pine trunks for curative treatment. In one embodiment, shaped pieces according to the invention are treated with Pochonia chlamydosporia and then applied to pine trunks for protective treatment.

1.8 Control of Insects (Several Species) Using Entomopathogenic Nematodes

The majority of insects attacking the wood of living trees belong to the order Coleoptera, but species of the orders Lepidoptera and Hymenoptera and Diptera are also found among the pests. The species damage the trees either directly under the bark, such as the bark beetle or the “wood borer moth” (Scolecocampa liburna), or they penetrate deeper into the wood, such as the brown sapwood beetle (Lyctus brunneus). It is the insect larvae in particular that cause the damage. However, these are often susceptible to entomopathogenic nematodes. Nematodes of the species Steinernema feltiae are already used commercially to control the larvae of the wood borer moth. FALLON et all. (Fallon D. J., Softer L. F. Keena M., Cate J. R. and Hanks L. M., 2004: Susceptibility of Asian longhorn beetle, Anoplophora glabripennis (Motchulsky) (Coleoptera: Cerambycidae) to entomopathogenic nematode. Biological Control, Vol. 30 (2): 430-438) report that the entomopathogenic nematode species S. feltiae and S. carpocapsae in particular attack and kill the larvae of the Asian longhorned beetle (Anoplophora glabripennis).

The spruce weevil (Hylobius abietis) is also known to be infected by entomopathogenic nematodes of S. feltiae, S. carpocapsae and Heterorhabditis downesi (Dillon A. B., Ward D., Downes M. J. and Griffin C. T., 2006: Suppression of the large pine weevil Hylobius abietis (L.) (Coleoptera: Curculionidae) in pine stumps by entomopathogenic nematodes with different foraging strategies. Biological Control, Vol. 38 (2): 217-226). But not only insects in trees can become targets of treatment with nematode-laden shaped pieces. Scientists have introduced entomopathogenic nematodes through holes or cuts in the rhizomes of banana plants and have observed a significant reduction in the infestation of these rhizomes with the banana weevil (Treverrow N. L., Bedding R. A, Dettmann E. B. and Maddox C., 1991: Evaluation of entomopathogenic nematodes for control of Cosmopolites sordidus German (Coleoptera: Curculionidae), a pest of bananas in Australia. Ann. Appl. Biol. Vol. 119: 139-145).

In one embodiment, shaped pieces according to the invention are loaded with Steinernema feltiae and subsequently applied to trees infested with larvae of the wood borer moth. In one embodiment, mouldings according to the invention are loaded with Steinernema carpocapsae and subsequently applied to the rhizome of bananas infested with the banana weevil.

2. Production of Fruiting Bodies of Edible Mushrooms or Pharmaceutically Used Mushrooms from Dead Wood

In one embodiment, shaped pieces according to the invention are loaded with mycelium of the edible fungus shiitake (Lentinula edodes) and then applied to trunk sections of oak (Quercus spp). The fruiting bodies growing out of the trunk section are harvested. In one embodiment, shaped pieces according to the invention are loaded with mycelium of the edible mushroom oyster mushroom (Pleurotus ostreatus) and then applied to trunk pieces of oak (Quercus spp). The fruiting bodies growing out of the trunk section are harvested. In one embodiment, shaped pieces according to the invention are loaded with mycelium of the medicinal fungus Ganoderma lucidum and then applied to trunk pieces of oak (Quercus spp). The fruiting bodies growing out of the trunk section are harvested. In one embodiment, shaped pieces according to the invention are loaded with mycelium of the medicinal fungus Trametes versicolor and subsequently applied to trunk pieces of oak (Quercus spp). The fruiting bodies growing out of the trunk section are harvested.

### 3. Production of Pharmaceutically or Otherwise Interesting Metabolic Products by Endophytic Fungi in Trees or Tree-Like Plants.

There are numerous endophytic microorganisms (especially fungi) that live in trees or tree-like plants and produce interesting pharmaceutically active metabolic products that can be used, for example, in cancer therapy. KARAWAR et al. (Kararwar R. N., Mishra A., Gond S. K., Stierle A. and Stierle D., 2011: Anticancer compounds derived from fungal endophytes: their importance and future challenges. Natural Product Reports 28 (7): 1208-1228) provide a comprehensive overview of the fungi used. For example, the cancer drug Taxol is obtained from the fungus Taxomyces andreanae in yew (Taxus spp.). However, the fungus can also produce the active substance in pine (e.g. Pinus ponderosa), coastal fir (Abies grandis) or larch (e.g. Larix occidentalis).

In one embodiment, shaped pieces according to the invention are inoculated with Taxomyces andreanae and then applied in yew. After a residence time, the yew is harvested and taxol is extracted from the wood. In one embodiment, shaped pieces according to the invention are inoculated with Taxomyces andreanae and then applied to fir. After a residence time, the fir is harvested and taxol is extracted from the wood. In one embodiment, shaped pieces according to the invention are inoculated with Taxomyces andreanae and then applied to pine. After a residence time, the pine is harvested and taxol is extracted from the wood. In one embodiment, shaped pieces according to the invention are inoculated with Taxomyces andreanae and then applied to larch. After a residence time, the larch is harvested and taxol is extracted from the wood.

### 4. Staining of Living Wood to Protect Against Illegal Exploitation

In many tropical countries, trees, e.g. ramin (Gonystylus bancanus) are cut in a predatory way in protected areas in order to market their valuable wood. The value of the timber would be significantly reduced if it were at least partially discoloured. Furthermore, in such a case, timber traders would immediately recognise that certain offered timber lots originate from illegal logging.

In one embodiment, shaped pieces of wood according to the invention are impregnated with a water-soluble dye and then applied to the trunks of protected trees.

The invention will then be explained in more detail using examples of embodiments, which are not intended to limit the invention.

### Example 1

The fungus Chondrostereum purpureum was isolated from the product Biochon. A magazine with 170 shaped pieces made of beech wood (Fagus sylvatica) in the form of wooden sticks with a diameter of 4.3 mm and a length of 65 mm was boiled for 30 minutes in a 0.4% potato-dextrose broth (biomol catalogue number P5200.500). The magazine was then dried in the air stream of a sterile workbench and subsequently autoclaved. The fungus C. purpureum was propagated in a shake culture in a shake flask at 100 rpm in a 0.4% potato dextrose broth. The resulting fungal mycelium was crushed with an Ultra-Turrax under the sterile bench until a homogeneous mycelial suspension was obtained. The suspension was poured into a beaker under sterile conditions and the magazine with the wooden sticks was immersed in the suspension. The magazine was then transferred to a sterile mushroom spawn bag and incubated in an incubator at 20° C. for 72 hours. The magazine-treated mouldings were dried again in the air flow of a sterile workbench. The procedure was repeated with several magazines.

The treatment of the wild black cherry was carried out in spring by sawing off shoots with a maximum diameter of 10 cm approx. 15 cm above the ground and placing a wooden stick treated with C. purpureum on each approx. 10 cm² of cut surface was injected using a gas cramping device (Alsaf ix AGRAFEUSE SANS FIL 12GASCR). A total of 100 plants were treated.

The evaluation of the trial took place in autumn of the same year. The typical symptoms of galena appeared on 93 treated plants. The resprouting was clearly impaired on 88 of the treated plants compared to untreated plants and on 50 plants the new shoots had already died during the current vegetation period.

A wood sample was taken from the treated stools about two centimetres below the cut surface. This was examined in the laboratory for the presence of the fungus C. purpureum. The fungus was detected in 97 of the 100 treated stools.

### Example 2

The strain Fo47 of F. oxysporum was provided by the company AGRENE (47 rue Constant Pierrot, 21000 Dijon, France). It is known from the literature that this strain is not pathogenic, but can be used to control pathogenic F. oxysporum strains. 90 wooden sticks made of birch wood (Betula spp.), diameter 5 mm, length 50 mm, were boiled for 30 minutes in a 0.4% potato-dextrose broth (biomol catalogue number P5200.500). The wooden sticks were then dried in the air flow of a sterile workbench and subsequently autoclaved. The fungus F. oxysporum was propagated in a shake culture in a shake flask at 100 rpm in a 0.4% potato dextrose broth. The resulting fungal mycelium was crushed to a homogeneous mycelial suspension using an Ultra-Turrax under the sterile bench. The suspension was poured into a beaker under sterile conditions and the moulded pieces were immersed in the suspension. The wooden pins were then transferred to a sterile mushroom spawn bag and incubated in an incubator at 25° C. for 72 hours. The treated mouldings were dried in the air flow of a sterile workbench to 15% wood moisture.

10 of the treated mouldings were sealed in 9 aluminium-coated plastic bags. Three bags each were stored at −10, 4 and 25° C. After 3, 6 and 12 months, the moulded pieces were removed from the bags and incubated for 7 days in Petri dishes on peptone yeast extract agar. It could be proven that F. oxysporum grew out of all treated wooden sticks. Even storage of the wooden sticks at 25° C. did not lead to inactivation of the fungus in any case.

### Example 3

The strain DSM 8567 of the gram-negative bacterium Pseudomonas fluorescens was propagated in a liquid peptone medium (Sigma-Aldrich, catalogue no. 77187) in shaking culture at 150 rpm. The concentration after completion of the culture was 3.2×10⁹ cfu per millilitre. The resulting bacterial suspension was placed in a vacuum vessel. 720 beech wood sticks (Fagus sylvatica), diameter 4.3 mm, length 65 mm, were completely immersed in the suspension, the vacuum vessel was closed and a vacuum of 0.1 bar was applied. After 20 min, the vacuum infiltration was stopped, the pressure in the vacuum vessel was raised to normal pressure again and the vessel was opened. The wooden pins were removed and dried in the air flow of a sterile workbench. In each case 180 wooden sticks were set to the following wood moisture contents: 10%, 20%, 25% and 30%. After drying, 30 wooden sticks were transferred into aluminium-coated plastic bags and sealed. Incubation took place at 4° and 25° C. After 3, 6 and 12 months, one bag of each of the 8 moisture-temperature variants was removed and the 30 wooden sticks contained therein were incubated on peptone-yeast extract agar at 25° C. After a further 5 days, the bacterial colonies were removed and incubated at 25° C. After a further 5 days, the bacterial colonies that had formed around the mouldings were counted. The result is presented in the following table:

TABLE
Number of bacterial colonies formed from 30 beech wood
sticks each after storage for 3, 6 and 12 months at wood
moisture contents in the wood sticks of 10, 20, 25 and
30% and incubation temperatures of 4° u. 25° C.

| | |
|---|---|
| Storage | Moisture content |

| period | Temperature | 10% | 20% | 25% | 30% |
|---|---|---|---|---|---|
| 3 Month | 4° C. | 30 | 30 | 30 | 30 |
| | 25° C. | 1 | 3 | 19 | 30 |
| 6 Month | 4° C. | 17 | 30 | 30 | 30 |
| | 25° C. | 0 | 2 | 19 | 30 |
| 12 Month | 4° C. | 5 | 23 | 30 | 30 |
| | 25° C. | 0 | 0 | 0 | 0 |

It became clear that P. fluorescens survives incubation in pieces of beech wood with 30% wood moisture for at least 6 months, even at a temperature of 25° C. The bacterium grows to 100% even after 12 months. At a temperature of +4° C., the bacterium grows out to 100% even after 12 months. In order for the bacterium to grow out of the mouldings, not all of the bacterial cells have to have survived. For the desired effect, it is sufficient if so many cells survive with the existing nutrient supply (nutrient solution was included in the moulded pieces) or have reproduced under the existing conditions that vital bacterial colonies grow out of the moulded pieces.

### Example 4

The strain SC1 of the fungus Trichoderma atroviride was isolated from the product Vintec of the company Belchim. The fungus was cultivated on a malt extract agar in Petri dishes under UV light. After 10 days, the cultures in the Petri dishes were blanketed with approx. 20 ml sterile tap water per Petri dish and the fungal conidia were scraped off the agar surface with the aid of a sterile spatula and suspended in the water. Approx. 400 ml of the conidial suspension obtained in this way was placed in a vacuum vessel. 170 shaped pieces made of red oak (Quercus rubra) according to FIG. 1c, Z-. X-. Y-direction 45×13×3 mm, angle α 90°, angle 13 60°, were completely immersed in the suspension, the vacuum vessel was closed and a vacuum of 0.1 bar was applied. After 20 min, the vacuum infiltration was terminated, the pressure in the vacuum vessel was raised again to normal pressure and the vessel was opened. The shaped pieces were removed, dried in the air flow of a sterile workbench and then magazined.

In autumn, 10 spruce trees infested with Armillaria (presumably Armillaria mellea) were treated with the treated shaped pieces in such a way that 5 shaped pieces each were shot into the trees at a distance of approx. 5 cm exactly at or in the immediate vicinity of the exit points of the fruiting bodies. The evaluation of the trial in autumn of the following year showed that
no more fruiting bodies of the Armillaria grew out of the infested trees,
the fungus Trichoderma atroviride could be isolated from the treated wood, and
the fungus Trichoderma atroviride could also be isolated from the rhizomorphs of the Armillaria mycorrhiza present under the bark.

### Example 5

The strain PL 251 of Purpureocillium lilacimum was isolated from the product BioAct WG of the company Andermatt.

100 beech wood (Fagus sylvatica) sticks, diameter 4.3 mm, length 65 mm, were boiled for 30 minutes in a 0.4% potato dextrose broth (biomol catalogue number P5200.500). The moulds were then dried in the air flow of a sterile workbench and autoclaved.

The fungus P. lilacinum was propagated in a shaking culture in a shaking flask at 100 rpm in a 0.4% potato dextrose broth. The resulting fungal mycelium was crushed with an Ultra-Turrax under the sterile bench until a homogeneous mycelial suspension was obtained. The suspension was poured into a beaker under sterile conditions and the sticks were dipped into the suspension. The wooden sticks were then transferred to a rigid mushroom spawn bag and incubated in an incubator at 25° C. for 120 hours. The treated wooden sticks were dried again in the air flow of a sterile workbench. They were then placed in an aluminium-coated plastic bag, sealed airtight and stored at 25° C.

The vitality of the fungus in the sticks was assessed after 18 months. For this purpose, the wooden sticks were removed from the bag and incubated on malt extract agar at 25° C. After a few days, the fungus P. lilacinum grew out of all the battens and showed vigorous colony formation after 14 days, evenly distributed around each of the wooden stakes.

### Example 6

10 shaped pieces, 6 mm in diameter, 60 mm long, made of stem tissue of the rattan palm (Calamus manan), with vessel diameters of up to 300 μm in the vascular bundles, were placed in a nematode suspension with the tip pointing upwards. The entomopathogenic nematodes of the species Steinernema carpocapsae used, length up to approx. 1 mm, diameter approx. 40 μm, came from the product Nemastar of the company e-nema GmbH. To prepare the nematode suspension, 5 g of the formulation was mixed in 200 ml of water. The moulded pieces were placed in the suspension in such a way that they were immersed to a depth of about 1 cm. Within 10 minutes, the moulded pieces were soaked in the suspension due to the capillary action of the pores in them, which was evident from the wetting of the tips protruding from the top. The moulded pieces were briefly dried on the surface and then placed in 2 ml of water with the tip pointing downwards, where they remained for 60 min. This time was allowed for the nematodes to migrate out of the moulds. After this time, the number of nematodes that emigrated again was determined in 4×20 μL of the newly formed nematode suspension under the microscope. An average of 66 nematodes per 20 μL was recovered, which corresponds to 6600 nematodes per 2 mL of water and 660 nematodes per shaped piece.

### Example 7

15 shaped pieces according to FIG. 1a, Z-. X-. Y-direction 65×20×4 mm, angle α 180°, angle 13 60°, made of hornbeam (Carpinus betulus) were incubated for 48 hours in blue ink (Pelikan 4001 washable) and then dried on a clean substrate (stainless steel plate). The moulded pieces were hammered into the trunk of a living birch (Betula spp.) at the beginning of June.

At the end of July of the same year, the birch was felled and the trunk section was cut into slices of approx. 30 cm length containing the shaped pieces. The tree slices were split in the direction of the fibres at the points where the shaped pieces had been driven in, using an axe. At all 15 shaped pieces, dye had diffused from the shaped pieces into the surrounding wood matrix and had stained it blue. The largest spread occurred in the direction of the fibres above the mouldings. The spreading length was up to 10 times the moulding width (X-direction).

### Example 8

10 shaped pieces each according to example 7 made of non-compacted (density approx. 0.7 g/cm³) and compacted hornbeam wood (Carpinus betulus) (density approx. 1.05 g/cm³) were boiled for 30 minutes in a 0.4% potato dextrose broth (biomol catalogue number P5200.500) and then kept in the solution for 24 hours. The non-compacted mouldings absorbed about 30% of the solution and largely retained their cross-section, while the compacted mouldings absorbed about 50% solution and swelled by about 40% in the direction of compaction.

### Example 9

24 shaped pieces according to FIG. 1c, Z-. X-. Y-direction 45×13×3 mm, angle α 90°, angle β 60°, made of beech wood (Fagus sylvatica) were impregnated with a neonicotinoid, a 7% imidacloprid solution (solvent dichloromethane) and then dried. The chips were shot 8 at a time into bark beetle-infested spruce trees using a gas cramping device (Alsafix AGRAFEUSE SANS FIL 12GASCR). After 3 weeks, the bark in the region 10 to 50 cm above the shooting sites was removed and the feeding tunnels exposed. No living larvae were found.

### Example 10

The pores of 40 shaped pieces additively produced from polyamide 6 reinforced with carbon fibre by the FLM process according to FIG. 5, Z-. X-. Y-direction 45×13×3 mm, angle β 60°, were filled with a slurry and then autoclaved. The pulp used had previously been prepared from wood powder (JRS, Arbocell C 100) with a grain size of approx. 100 μm and a malt extract yeast broth in a ratio of 1 to 4. The malt extract yeast broth contained 1% gel-forming agar powder. After sterilisation, the mouldings were sprayed under the sterilisation bench with a conidial suspension of the fungus Trichoderma viride (strain SC1) and incubated at 25° C. under high humidity. After 48 hours, the moulds were laid out to dry and then transferred 10 at a time into 4 aluminium-coated plastic bags. The bags were hermetically sealed and stored at 25° C. After 3, 6, 9 and 12 months, the moulded pieces were removed from one bag each and placed on malt extract yeast agar. This showed that the fungus grew out of all the moulded pieces in every case, even after 12 months.

1.-80. (canceled)

81. A method for the treatment of plant tissue having a capillary system with active substances and/or dyestuffs, comprising applying to the plant tissue a shaped piece containing openings in and/or surface structure on at least one surface of the shaped piece with the aid of a setting tool or setting device, wherein the openings or surface structure are loaded with the active substance and/or dyestuff.

82. The method according to claim 81, wherein the surface structure comprises grooves and/or knobs.

83. The method according to claim 81, wherein the shaped piece has a configuration that ensures that no air penetrates into the capillary system of the plant tissue during use.

84. The method according to claim 81, wherein the active substances consist of synthetic or bio-based non-living substances or of living microorganisms or organs of microorganisms and, wherein the dyes consist essentially of water-soluble dyes.

85. The method according to claim 81, wherein the shaped piece comprises a tip, a shaft and a head, wherein the shaped piece further comprises natural pores, the openings and/or surface structures, and wherein the natural pores, the openings and/or surface structures are suitable for receiving the active substances and/or dyestuffs.

86. The method according to claim 81, wherein the shaped piece comprises a tip, a shaft and a head, wherein the shaped piece has a cross-section which makes it difficult for the plant tissue to tear when the shaped piece is set in place or, if tears do occur, is adapted to the shape of the tear in such a way that the tear flanks of the plant tissue press against the shaped piece.

87. The method according to claim 83, wherein the shaped piece comprises a tip, a shaft and a head, wherein the shaped piece further comprises natural pores, the openings and/or surface structures, and wherein the natural pores, the openings and/or surface structures are suitable for receiving the active substances and/or dyestuffs.

88. The method according to claim 83, wherein the shaped piece comprises a tip, a shaft and a head, wherein the shaped piece has a cross-section which makes it difficult for the plant tissue to tear when the shaped piece is set in place or, if tears do occur, is adapted to the shape of the tear in such a way that the tear flanks of the plant tissue press against the shaped piece.

89. The method according to claim 84, wherein the shaped piece comprises a tip, a shaft and a head, wherein the shaped piece further comprises natural pores, the openings and/or surface structures, and wherein the natural pores, the openings and/or surface structures are suitable for receiving the active substances and/or dyestuffs.

90. The method according to claim 84, wherein the shaped piece comprises a tip, a shaft and a head, wherein the shaped piece has a cross-section which makes it difficult for the plant tissue to tear when the shaped piece is set in place or, if tears do occur, is adapted to the shape of the tear in such a way that the tear flanks of the plant tissue press against the shaped piece.
